(19) United States
(12) Patent Application Publication
(10) Pub. No.: US 2017/0337634 A1
(43) Pub. Date: Nov. 23, 2017

(54) LOCATION AND MILEAGE TRACKING SYSTEM AND METHOD

(71) Applicant: Hi Road 5 LLC, Ridgewood, NY (US)

(72) Inventors: Chad David Ehrlich, Ridgewood, NY (US); Robert Berman, New Hope, PA (US)

(73) Assignee: Hi Road 5 LLC, Ridgewood, NY (US)

(21) Appl. No.: 15/357,118

(22) Filed: Nov. 21, 2016

Related U.S. Application Data
(60) Provisional application No. 62/337,732, filed on May 17, 2016.

(51) Int. Cl. G06Q 40/00; H04L 29/08; G01C 21/34; H04W 4/02; H04L 29/06; H04L 12/58

(52) U.S. Cl. CPC G06Q 40/12; H04W 4/02; H04L 67/42; H04L 67/306; G01C 21/34; H04L 67/10; H04L 67/06; H04L 67/22; H04L 51/22

(57) ABSTRACT

A method and system for creating an electronic record of traveled location and distance, the method comprising receiving user information at an application server from a client device through a communication network, transmitting, by the application server, a signal to enable navigational tracking of the client device to record location data, the location data including an origination address and a destination address, receiving, by the applications server, the location data at the application server from the client device through the communication network, determining, by the application server, the user arrived at the destination address and distance traveled based on the location data from the client device, populating, by the application server, a digital form with the location data, the distance traveled, and the user information, and transmitting the digital form from the application server to one or more receiving party devices.

### CROSS REFERENCE TO RELATED APPLICATION

This application claims the priority of U.S. Provisional Application No. 62/337,732, entitled “A MEANS FOR TRACKING, POPULATING AND AUTOMATICALLY SUBMITTING WORKERS COMPENSATION MILEAGE AND TRANSPORTATION REIMBURSEMENT FORMS,” filed on May 17, 2016, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to location tracking, and in particular, electronic tracking of location and distance traveled with a mobile device and creation of a record thereof.

### Description of the Related Art

Claimants are very discouraged from obtaining medical and transportation (“M&T”) reimbursements, e.g., medical and travel expenses, workers' compensation, etc., due to the current hassle of the reimbursement process. Current ways of executing M&T reimbursement forms are outdated, and many must be filled out on paper. As a result, only a small percentage of claimants submit their M&T reimbursement forms, even though they are legally due reimbursement. Various compensation M&T reimbursement forms are very difficult to locate and the exact instructions can get very confusing. This is a time consuming process for the claimant and many times the claimant may feel that it isn't worth the cents per mile the claimant would be reimbursed.

Claimants are required to have adequate documentation in order to receive reimbursement from parties such as health insurance carriers. Submission of the M&T reimbursement form is a way of verifying the claimant did, in fact, attend, for example, their doctor's appointment. If there is a doctor bill with a date not listed on a routinely submitted M&T reimbursement form, this will be a red flag for the insurance carrier that fraud may be taking place. There is also no direct way to calculate the mileage to and from the claimant's resident address to the doctor's address. There is no standardized way to calculate the mileage traveled, causing disputes between carriers and claimants. It is very difficult for claimants to manually track miles to and from appointments such as the doctor's office, independent medical examination (“IME”) exam, hearings, toll costs, public transportation costs, parking costs, pharmacy visits, vocational rehab services, etc. Many carriers use readily available mapping technology (for example, Map Quest or Google Maps), and there are different routes that can be taken causing discrepancies.

There is no standardized method for tracking the claimant's miles traveled to and from their different reimbursable appointments.

### SUMMARY OF THE INVENTION

The present invention provides a method, system, and non-transitory computer readable media for creating an electronic record of traveled location and distance. The method comprises receiving user information at an application server from a client device through a communication network, transmitting, by the application server, a signal to enable navigational tracking of the client device to record location data, the location data including an origination address and a destination address, receiving, by the applications server, the location data at the application server from the client device through the communication network, determining, by the application server, that the user arrived at the destination address and distance traveled based on the location data from the client device, populating, by the application server, a digital form with the location data, the distance traveled, and the user information, and transmitting the digital form from the application server to one or more receiving party devices.

The user information may contain information for one or more doctors including doctor's name, doctor's business practice name, federal employer identification number, and business address. A scan or photograph of reimbursable items may also be received. The signal to enable the navigational tracking may include a control signal. In at least one embodiment, the location data includes a mode of transportation.

The method may further comprise determining a shortest route between the origination address and the destination address based on information received from a navigation server. According to one embodiment, populating the digital form may further include populating the digital form with the distance traveled based on the shortest route. Toll payments may also be determined based on the location data. The navigational tracking may be concluded upon determining a return to the origination address from the destination address.

The digital form may be transmitted via any one of email, fax, or electronic file transmission over a network. The method of claim 1 further comprising scheduling the transmission of the digital form to the one or more receiving parties at predetermined intervals.

The system comprises a processor and a memory having executable instructions stored thereon that when executed by the processor cause the processor to receive user information from a client device through a communication network and transmit a signal to enable navigational tracking of the client device to record location data, the location data including an origination address and a destination address. The processor further receives the location data from the client device through the communication network, determines the user arrived at the destination address and distance traveled based on the location data from the client device, populates a digital form with the location data, the distance traveled, and the user information, and transmits the digital form to one or more receiving party devices.

The location data may include a mode of transportation. According to one embodiment, the processor determines a shortest route between the origination address and the destination address based on information received from a navigation server. The processor can transmit the digital form via email, fax, or electronic file transmission over a network. A scan or photograph of reimbursable items may also be received by the processor.

The non-transitory computer readable comprises computer program code for receiving user information from a client device through a communication network, computer program code for transmitting a signal to enable navigational tracking of the client device to record location, the location data including an origination address and a destination address, computer program code for receiving the location data from the client device through the communication network, computer program code for determining that the user arrived at the destination address and distance traveled based on the location data from the client device, computer program code for populating a digital form with the location data, the distance traveled, and the user information, and computer program code for transmitting the digital form to one or more receiving party devices.

The location data may include a mode of transportation. The non-transitory computer readable media may further comprise computer program code for determining a shortest route between the origination address and the destination address based on information received from a navigation server. The non-transitory computer readable media my further comprise computer program code for transmitting the digital form via email, fax, or electronic file transmission over a network.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for creating an electronic record of traveled location and distance according to an embodiment of the present invention;

FIG. 3 illustrates a mobile computing device according to an embodiment of the present invention; and

FIG. 4 illustrates a Web/application server device according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The present application discloses using global positioning system (“GPS”) navigation or other location tracking methodologies to create an electronically corroborated record of miles traveled between two endpoints and to automatically populate fields of digital forms using the record. According to one embodiment, travel location data along with other information may be uploaded to an application server for populating and submitting M&T reimbursement forms that are in compliance by law in a given governing jurisdiction. It is noted that the following description is discussed with respect to workers' compensation, however, it is understood that embodiments of the present invention can be applied to a wide variety of industries, for example, where there is a reimbursement for transportation expenses such as reimbursement for company travels, Veteran Affairs, no fault insurance, Medicare, Medicaid, TRICARE, and Social Security disability benefits.

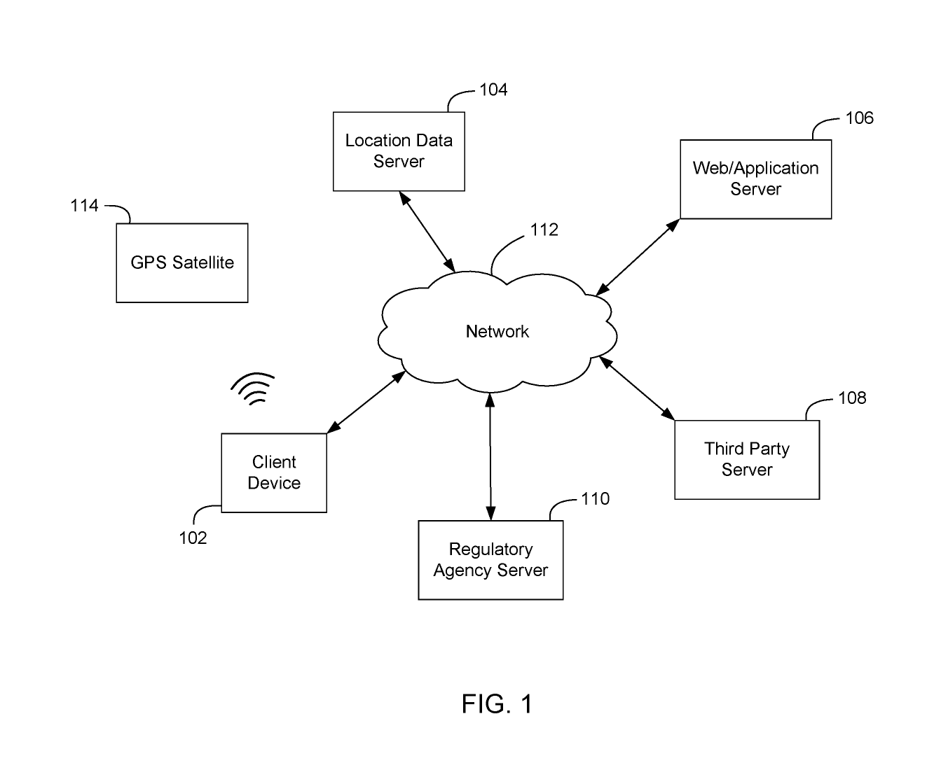

FIG. 1 presents a networked computing system according to an embodiment of the present invention. The networked computing system includes client device 102, navigation server 104, Web/application server 106, third party server 108, regulatory agency server 110, network 112, and GPS satellite 114. Client device 102 may comprise computing devices (e.g., desktop computers, terminals, laptops, personal digital assistants (PDA), cell phones, smartphones, tablet computers, e-book readers, smart watches and wearable devices, or any computing device having a central processing unit and memory unit capable of connecting to a network). The client device may also comprise a graphical user interface (GUI) or a browser application provided on a display (e.g., monitor screen, LCD or LED display, projector, etc.). A client device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. A client device may also include or execute an application to communicate content, such as, for example, textual content, multimedia content, or the like.

A client device may include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Pinterest, Instagram, or Google+, to provide only a few possible examples.

Client device 102 may also include or execute an application to perform a variety of tasks to allow users (e.g., claimants) of client device 102) to easily and efficiently upload information to Web/application server 106, which may then use the information to automatically fill out M&T reimbursement forms. Users may save or load to Web/application server 106, maps of travels, M&T reimbursement forms, emails sent, reconciliation statements, a list of their doctor's information (Federal Employer Identification Number (“FEIN”), business name, doctor name, doctor address), all reimbursable items, doctors appointment authorization/electronic signature page, page of all receipts uploaded via picture or barcode, penalty tracking and penalties owed page, etc. Information submitted via the application or website may be transferred to one or more M&T reimbursement forms by means of an “auto fill” feature on Web/application server 106 that can populate fields of M&T reimbursement forms. In another embodiment, the auto fill feature may be embodied on the application or website. The application and the website may contain specific M&T reimbursement forms, which can be manually updated and saved by the user. Information may also be manually entered into the M&T reimbursement forms and saved onto the client device 102 or Web/application server 106 if not completed. Web/application server 106 may include a database that can be used as an online storage of, for example, M&T reimbursement forms from a plurality of states or municipalities, as applicable. The application and website may have electronic copies of specific forms, e.g., each states' M&T reimbursement form—for states without their own standardized M&T reimbursement form, a M&T reimbursement form may be generated based on each respective state laws.

According to one embodiment, users may create an account by using the application or access a website provided by Web/application server 106. Each user may be prompted to create a unique login and password for their account and assigned a unique identification number. Users may also be asked to submit information (of themselves if they are the claimants, or of the claimant if the user is a caregiver or assistant) for certain forms, such as for specific states' M&T reimbursement forms, including, but not limited to, a claimant's name, claimant's email, case manager name, case managers email, attorneys name, attorneys email, a worker's compensation board (WCB) case number or jurisdiction case number, social security number, carrier case number, residential or home address, mailing address (if different), employers name, and state where claim is filed. The website and application may further ask for information of each doctor or therapist the claimant will be attending. Doctors/therapists information include doctor name, doctor's business name, doctor business address, and doctor federal tax ID number. The user can type in and select a doctor's name from a drop down, and all doctor's information can be prepopulated.

GPS navigation or geolocation tracking features of client device 102 may be used in conjunction with navigation server 104 and/or GPS satellite 114 to determine the user's travel distance to all of their reimbursable appointments. The location of the user, via client device 102, may be access when the application or website is being used. The user's travel distance can be determined without discrepancies, as it can determine location using navigation technology. Additionally, mapping technology via navigation server 104 (e.g., MapQuest or Google Maps) can be used to determine the route and distance to their reimbursable appointment and the shortest route and distance to their appointment. For example, the application and website can use the mapping technology to determine exactly how many miles it takes to get from a claimant's residential address to the doctor's office. A user may preview or see a route from their home or origination to a destination prior to or during a visit travel.

Reports may be generated using GPS distance traveled to and from the claimant's reimbursable appointment in addition to a most efficient distance based on mapping technology. Such distance and route reports may be used by client device 102 or Web/application server 106 to automatically populating an online M&T reimbursement form. Additionally, maps of the user's route taken can be recorded and viewed through the application and the website. A user may view a visual map of visits for particular dates including an actual route traveled for a reimbursable visit and a shortest route determined using mapping technology. The application or website may further include a distance calculator operable to calculate the total distance traveled per day, month, year, etc. According to an alternative embodiment, the user may also have the option to not to use navigation. If such an option is selected for a visit, an indication of such may be indicated on a M&T reimbursement form corresponding to the visit. For example, a footnote on the M&T reimbursement form may state distance in bold was not tracked by GPS, and was manually inputted by the user.

The application and website may also provide information on what is reimbursable. For example, visits that can be reimbursable in New York State may include doctor visits, physical therapy, chiropractic visits, testing (e.g., drug screening), MRI's, X-rays, ER visits, hospital stays, and IME, and visits that may not be reimbursable include trips to the pharmacy to drop off or pick up prescriptions, trips to the attorney's office, and WCB Hearings, and other expenses that can be reimbursable may include miles, bridge and ferry tolls, parking, vocation rehabilitation visits, retraining classes, commercial transportation, lodging, and meals (breakfast, lunch, diner, etc.). Additionally, a toll tracking feature may keep track of when the user goes through a toll and the dollar amount of the toll. A reimbursement calculator is able to calculate the amount of the claimant's reimbursement based on the miles traveled at each states' respective reimbursable mileage rate plus tolls, and inform claimants of their rights to what is reimbursable and what isn't reimbursable (e.g., depending on state).

Client device 102 may further include barcode scanning technology for scanning the barcode of reimbursable items for loading into the application. Additionally, photographic technology can be used for reimbursable items without a barcode. For example, the user may scan a barcode through the application or take a picture of the receipt of the reimbursable item when no barcode is available, which can then be submitted and uploaded to a database on Web/application server 106. Pictures uploaded and barcodes scanned using the application may be viewed on the application or website.

A record of a reimbursable visit may be generated for review by the user upon an arrival back home. The record may include a mode of transportation, a doctor/therapist attended and their address, date, miles traveled, a route traveled or a shortest route, and a calculated total reimbursable amount for the visit may be presented. The record may present the information in separate tabs or pages for transportation reimbursement details and other reimbursable items (e.g., medical reimbursement for prescriptions and durable medical equipment). This allows for the clamant to see how much he/she is entitled to be reimbursed directly after arriving home, similar to a bank statement. A user may be able to break down reimbursement by a specific date, month, year, and total reimbursement received. The user may also view reconciliation on a weekly, monthly, or yearly, etc., basis.

According to one embodiment, electronic signature technology can be used for providers to easily provide their signature to approve of a claimant's appointment. A doctor/therapist may login to Web/application server 106 to access an electronic signature page to provide their online electronic signature for confirming an appointment with a claimant (e.g., for states where this is required). Unique identifiers may be used to track each claimant, doctor and therapist. A doctor may log in, enter an identifier that corresponds to the visiting claimant, and provides their electronic signature. A check mark may be placed near the lines on a M&T reimbursement form in which the doctor/therapist have provided their electronic signature. Date verification can be used to track when the claimant attended their appointment, when forms are sent, etc. A time/calendar tracking feature may record the exact time and date of all interactions and functions on the application and website.

M&T reimbursement forms may be submitted via email, mail, electronic file transmission, and fax or electronically (following any specific state requirements for submission) from Web/application server 106 using information or documents received from client device 102. In one embodiment, an auto send feature may be enabled to automatically send the claimant's M&T reimbursement form and any penalty follow up notice via email, fax or mail (or any other electronic delivery methods) at periodic intervals, e.g., each month, at requested intervals to all necessary parties at third party server 108 and regulatory agency server 110. According to another embodiment, database interchange technology may be used to send the claimant's M&T reimbursement form stored on a database from Web/application server 106 directly to third party server 108 and regulatory agency server 110. In yet another embodiment, the user may manually select a M&T reimbursement form to submit to an insurance carrier, regulatory authority, attorney, and a copy to the claimant themselves (e.g., the claimant's email address). Alternatively, the user can also print the M&T Reimbursement form to manually execute.

A validation page may be generated for users to see the exact date or a number of days elapsed from when M&T reimbursement forms were sent to all parties, and when penalty emails were sent (if applicable). The user may be notified of when the claimant should collect a penalty payment and have proof of submission, holding the insurance companies accountable for delayed, or non-payment. The application or website may keep track of the months in which a claimant has received their reimbursement and follow up with the claimant after a specific period of time, e.g., 45 days, with a notification asking if they have received their reimbursement. For example, a prompt or popup notice may ask whether reimbursement has been received within ‘X’ days of submission with a ‘yes’ or ‘no’ option. If the user selects “yes,” a confirmation of the reimbursement is recorded, or the user may be navigated to check a tick box of for reimbursement received. Otherwise, if the user selects “no,” a hyperlink notification may be generated to remind the claimant to call their case worker and/or send a follow-up email to the claimant including a form used to initiate a hearing for the claimant such as a “RFA1” form can be submitted to the insurance carrier, regulatory agency, claimant's attorney, and the claimant.

According to one embodiment, if a claimant does not have an attorney on file or registered with the application, a prompt may be presented asking if a referral to an attorney is desired by the claimant. A lead bidding system for attorneys may be provided by the application or website. The user may allow and choose to be contacted by an attorney (e.g., within the next day or two). Attorneys may create accounts with Web/application server 106 to access leads resulting from such claimants. Web/application server 106 may rank the claimant according to different categories, such as claimants who had surgery, claimants who are being treated frequently and had a magnetic resonance imaging (MM), claimants who only go to their doctor, e.g., 1-2 times a month. The attorneys may be charged a small monthly fee to access these leads. According to anther embodiment, attorney services may also be solicited when claimants submit reimbursement claims and don't have an attorney on file. For example, a notification may be presented to the user with the message, “you can receive 50% more for your claim when you hire an attorney.”

Additionally, a penalty tracker feature may be enabled for handling penalties that are due for late or non-payment of mileage reimbursement. If a certain reimbursement is not received by the claimant within an allotted time, the penalty tracker may be automatically triggered. The penalty tracking may include a counter for when penalties are due such as from a M&T reimbursement form submission date. For example, a carrier must reimburse in 45 days in New York (may vary from state to state) or else the claimant receives a 10% penalty based on the amount of the M&T reimbursement amount. If the penalty counter has one day left, it may send a notification to the user through the application. If the penalty counter has zero days left, an email/fax/letter may be automatically sent to the insurance carrier, regulatory agency, and the attorney (as applicable). Customer support, contact, and frequently ask questions pages, links, or menus may be available to assist users for issues such as why a reimbursement may be rejected. Live customer support may be available to allow a user to speak, chat, or text with a live representative through the application and website.

Third party server 108 is representative of one or more servers that processes the M&T reimbursement forms or submissions for reimbursement such as an insurance carrier. Regulatory agency server 110 is representative of one or more servers of a regulatory agency for recording M&T reimbursement submissions. Communications and content stored and/or transmitted to and from client devices and servers through network 112 may be encrypted using, for example, the Advanced Encryption Standard (AES) with a 256-bit key size, or any other encryption standard and protocols known in the art. Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like.

Network 112 is representative of one or more networks of any suitable type that allow transport of data communications across thereof. The network 112 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof.

Web/application server 106 may further provide auditing tools including different macros (or program code) that can be used and altered by each respective party or insurance carrier to audit M&T reimbursement forms. The auditing tools can allow a case manager to easily distinguish what travels are payable and which aren't payable. According to one embodiment, the auditing tools include generating spreadsheets of the claimant's M&T reimbursement information that correlates with the carriers billing system information. The Web/application server 106 may submit information from the M&T reimbursement form in a spreadsheet created by the application or website. Billing information may be exported from an insurance carrier's billing system into another spreadsheet created by the application or website.

A macro may be used with the spreadsheet that is submitted with the claimant's M&T reimbursement form and the insurance carriers own billing information. An auditor process can then copy and paste the claimant's M&T reimbursement form information and the insurance carriers billing information from the spreadsheets into a macro provided by Web/application server 106. The macro may cross reference both information to produce results of a M&T reimbursement. Results of the cross referencing may show which lines from the M&T reimbursement form are payable, which lines must be further investigated, and which lines are denied. The macro can also display the dollar amount breakdown for each section, lines payable, lines in need of further investigation, and lines denied. The macro will be able to sort out bills, for example, in which the claimant may have gone to the doctor, however the carrier objected to the doctor bill. If a carrier objects to a doctor bill, the claimant cannot be reimbursed for that visit.

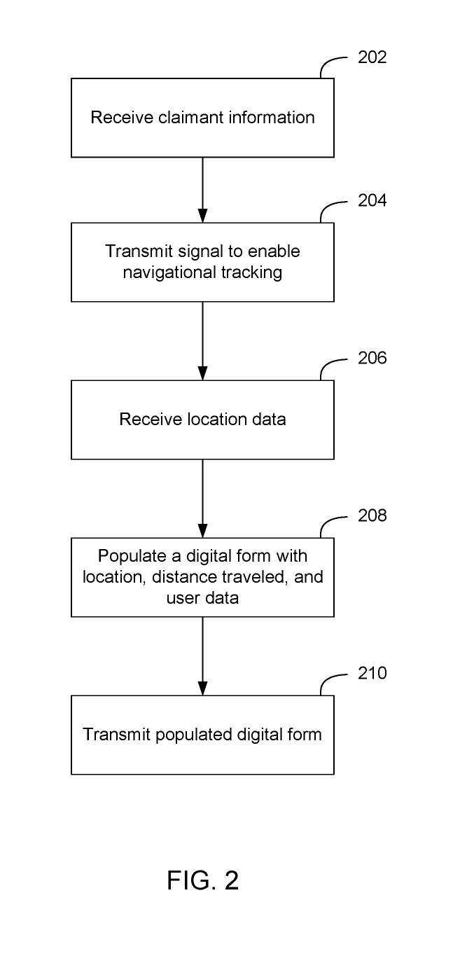

FIG. 2 presents a flowchart of a method for creating an electronic record of traveled location and distance according to an embodiment of the present invention. Claimant information is received by an application server, step 202. A claimant may create a username and password for an account through an application or website on a mobile client device. The claimant may be required to enter any information necessary to complete a given form, such as for M&T reimbursement forms, information of each respective doctor/therapist the claimant is seeking treatment from including doctor's name, doctor's business practice name, FEIN, business address, and any other pertinent information.

A navigational tracking mechanism or GPS of the mobile client device is enabled for usage by the application by transmission of a control signal, message, or the like from the application server for tracking reimbursable visits or travel, step 204. Optionally, the application server may maintain a connection or communications with the client device for a duration of an event such as while the application is active or in use. A mode of transportation and a destination may be selected (e.g., name of a doctor or an identifier that corresponds to that doctor). Available modes of transportation may include car, taxi, train, subway, ferry, etc. Location tracking with the application on the mobile client device may be activated after the selections and begins retrieving and recording data for location and distance from an origination to a destination (e.g., the claimant's residential address to the doctor's address).

The application may pre-populate a total cost of travel incurred based on the origination and destination selected by the claimant. For example, the distance between the claimant's residential address and the business address(es) of a doctor may can be used to calculate a reimbursement amount on a predetermined cost per mile for each mode of transport. If car is selected, the application may calculate the round trip miles from the claimant's residential address to their selected doctor's office (e.g., based on a shortest route determined based on information from a navigation server). A reimbursement goal for travel by car may be provided with details such as cost from claimant's residential address to doctor's address, cost from doctor's address to claimant's residential address, and total cost (sum of cost to and from the doctor). If train, ferry, or taxi is selected, the claimant may be allowed to bring up a screen on the application to allow scanning a barcode or taking a picture of a receipt. If subway is selected, round trip miles may be calculated based on the price for a round-trip subway ride. The claimant may also be asked to select a reason for appointment from a list of services including doctor's visits, physical therapy, chiropractic visits, testing (drug screening), MRI's, X-rays, ER visits, hospital stay, IME, or other reasons that the claimant can provide. The application may calculate notify how much the claimant will be reimbursed for the trip based on the selections.

The claimant may be able to see whether or not they are being tracked by the location tracking or GPS and can manually turn the tracking off and on, as desired. The application may continuously monitor and record the location (and distance) traveled for the duration of travel and may be configured to remain activated until the claimant returns to the origination. Recording of the location by the application can be paused, e.g., upon determining an arrival at the destination (or manually), and resumed when leaving the destination. According to one embodiment, the application may also record a timestamp of the locations or distance traveled to ensure authenticity of the data. The application may also automatically detect the payment of tolls (or passage through a toll road) and the cost per toll. The application is able to determine when the claimant returns to the origination from the destination and may cause the recording of the location by the application to conclude, thereupon, tracking detail from the recording may be uploaded to the application server (automatically or manually). Additionally, the tracking details can be saved into a record of owed reimbursements in the application.

The application server receives the location data from the application on the mobile client device, step 206, and populates the location data into one or more fields of a digital form along with the claimant's information, step 208. For example, information such as mode of transportation, doctor/therapist attended and their residential address, date, miles traveled, and calculated total reimbursable amount for the visit may be submitted for claims from the application to the application server, where the information is used to fill out the digital form. Populating the one or more fields of the digital form may include identifying the fields of the digital form and determining which of the location data and the claimant's information correspond to the identified fields. Fields of a digital form may be performed by optical character recognition (“OCR”), examining metadata, or header elements of a digital form.

The digital form populated by the application server is transmitted to designated parties, step 210, such as the insurance carrier, regulatory agency, and attorney (as applicable). The submission may be performed automatically at predetermined intervals or manually initiated by selecting a “send” button. Submissions may be sent to a particular email address, fax number, FTP address, or other electronic addresses or identifiers of designated parties. In one embodiment, a claimant may be allowed to request and submit a plurality of versions of each digital form. A first version may contain miles traveled by the claimant as determined by GPS tracking or navigation. A second version may contain round trip miles based on a shortest route determined based on information from a navigation server. Optionally, a third version may include a spreadsheet to be used with a carriers' auditing macro.

In one embodiment, the claimant may be able to request a physical printout including a completed digital form if the claimant desires to physically mail the form to a mailing address. The printout may also include a map generated using data from a navigation server that displays the origination address, destination address, route taken, and total miles. Any pictures taken and scanned receipt information are supplemental items that may also be included in the printout. The claimant may provide a confirmation that the digital form has been mailed.

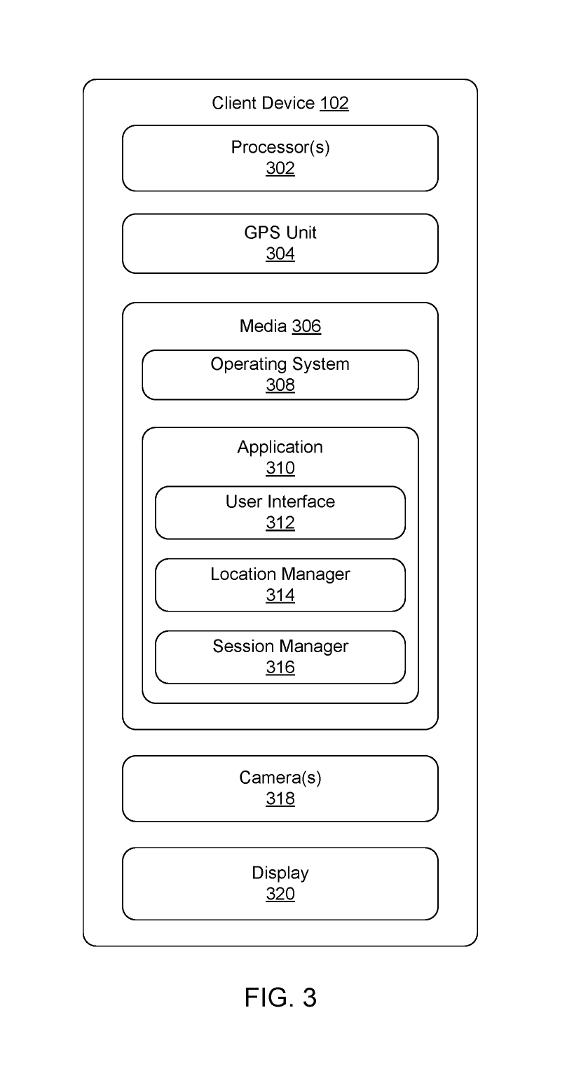

FIG. 3 presents an illustration of an example embodiment of client device 102. Client device 102 includes one or more processors 302, GPS unit 304, computer-readable storage media (“media”) 306, camera(s) 318 and display(s) 320. Media 306 includes an operating system 308 and application 310. Application 310 includes or has access to one or more of a user interface 312, a location manager 314, and session manager 316, and is configured to communicate with Web/application server 106. The application 310 may be either a website browser application or a downloadable application able to communicate with Web/application 106.

User interface 312, shown included in application 310, presents options for registering a user, generating a record of a visit between an origination and a destination, and transmitting location data associated with client device 102 to Web/application server 106. A user is able to register a user profile by entering information such as full name, email address, password, and residential address (which may be automatically populated by predictive text using, e.g., Google Places). An on-boarding tutorial may also be provided for navigating and using user interface 312 upon registering or selection from a settings menu. The user can search for visit destinations, such as doctors, by name. The destinations may be presented with a predictive search result as the name is typed or the user can input a complete name and search for relevant results. Search results may be provided with information about a destination, for example, doctor first and last name, credentials, specialty, business phone/telephone number, and business address(es). If a name is not found, the user may be able to add a new name. Multiple destinations may be selected and added to a user's profile.

Location manager 314 is operable to aid in determining routes, navigation, and the geographic location of mobile device 102 based on cellular triangulation, GPS signals received and transmitted from GPS unit 304, or in other manners. Additionally, location manger 314 may determine a traveling speed of the user to confirm a mode of transportation. Session manager 316 may manage current and historical data about mobile device 102 and its user, and record data for user sessions (e.g., visits) such as mode of transportation, purchases, geographical location (optionally including speed and time), origination, destination, scans or photographs of receipts, etc. Camera(s) 318 allow capturing of images or photographs of receipts or barcodes for upload to Web/application server 106 to provide proof of travel to and from using certain mode(s) of transport such as by taxi. Receipts may be tagged, annotated, or associated with a cost or reimbursement amount reflected in the receipts. Images and associated data uploaded to Web/application server 106 may be viewed, updated, and deleted.

A user is able to enter and track sessions by entering details such as a destination (or business) name or identifier, a reason for the visit, date of visit (e.g., current date displayed by default), and mode of transport. Reimbursement costs may be calculated for each session based on mode of transport data recorded using GPS unit 314. The user can navigate to an owed reimbursement details page to view a list of sessions that have not been submitted by date of visit, mode of transport, mileage (e.g., total distance traveled), and claim amount. A sum total of claim amounts for all owed reimbursements may be displayed. Details about each owed reimbursement may be view including date of visit, destination name, reason for visit, destination address, origination address, distance total, mode of transport, and pricing details. Any uploaded receipts for taxi or other non-car travel items may also be retrieved. For car reimbursements, a map image including a start and end point may be viewable showing the driving route along with origination address, destination address and total miles.

Application 310 may be configured to upload reimbursement details data to Web/application server 106 with or without an explicit request from the user. Automatic submission of claims may be configured on application 310. According to one embodiment, a plurality of sessions including reimbursement details data may be submitted for claims by batch processing (scheduled on a periodic basis, e.g., at the end of each month), or upon conclusion of each tracked user session. Each claim that is submitted may be subjected to a fee charged to the user. Fees may be automatically charged to a payment method added by the user. If the user has not added a payment method yet, they may be prompted to add it to be able to set up a submission of reimbursement claim(s).

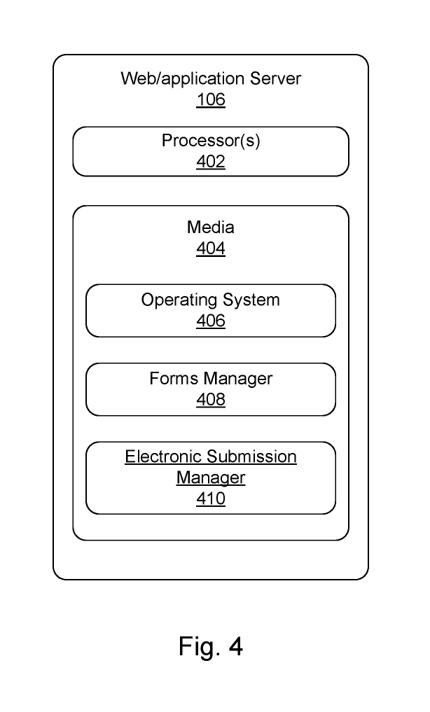

FIG. 4 presents a Web/application server device according to an embodiment of the present invention. Web/application server 106 includes one or more remote processors 402 and computer-readable storage media (“media”) 404. Media 404 includes operating system 406, forms manager 408 and electronic submission manager 410. Forms manager 408 may be configured to receive data from client device 102, retrieve digital forms, and populate the digital forms based on the received data either alone or in combination with other entities described herein. The forms manager 408 may further include a database of digital forms from which the digital forms are retrieved. Alternatively, digital forms may be uploaded to forms manager 408 from client device 102. The forms manager 408 may include or have access to entities similar or identical to session manager 316. Completed or partially completed forms may be stored to a cache (not illustrated) where they may be accessed and retrieved.

Forms manager 408 may cause client device 102 to notify a user of certain events through user interface 312. For example, forms manager 408 may send a text, email, or markup-language document to client device 102 in response to which client device 102 notifies the user through user interface 312, such as through presenting the text message or email, or rendering the markup-language document as hyper-text machine language, to name just a few examples. The certain events may include a status of information transferred between client device 102 and Web/application server 106, form population status, claim submission status, confirmation of form submission, reimbursement status, etc.

Electronic submission manager 410 is operable to manage transmission of completed digital forms associated with a plurality of user accounts to third party devices. The transmissions may include digital/electronic transmissions between electronic devices including, but not limited to, email, file transfers, fax, and other electronic data communications. Transmissions made by electronic submission manager 410 are configurable by scheduling preferences according to the plurality of user accounts. Logs or receipts may be received from the third party devices and used to generate submission reports that can be stored within web/application server 106 and communicated to client devices 102.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method for creating an electronic record of traveled location and distance, the method comprising:
receiving user information at an application server from a client device through a communication network;
transmitting, by the application server, a signal to enable navigational tracking of the client device to record location data, the location data including an origination address and a destination address;
receiving, by the applications server, the location data at the application server from the client device through the communication network;
determining, by the application server, the user arrived at the destination address and distance traveled based on the location data from the client device;
populating, by the application server, a digital form with the location data, the distance traveled, and the user information; and
transmitting the digital form from the application server to one or more receiving party devices.

2. The method of claim 1 wherein the user information contains information for one or more doctors including doctor's name, doctor's business practice name, federal employer identification number, and business address.

3. The method of claim 1 further comprising receiving a scan or photograph of reimbursable items.

4. The method of claim 1 wherein the signal to enable the navigational tracking includes a control signal.

5. The method of claim 1 wherein the location data includes a mode of transportation.

6. The method of claim 1 further comprising determining a shortest route between the origination address and the destination address based on information received from a navigation server.

7. The method of claim 1 wherein populating the digital form further includes populating the digital form with the distance traveled based on the shortest route.

8. The method of claim 1 further comprising detecting toll payments based on the location data.

9. The method of claim 1 further comprising concluding the navigational tracking upon determining a return to the origination address from the destination address.

10. The method of claim 1 further comprising transmitting the digital form via email, fax, or electronic file transmission over a network.

11. The method of claim 1 further comprising scheduling the transmission of the digital form to the one or more receiving parties at predetermined intervals.

12. A system for creating an electronic record of traveled location and distance, the system comprising:
a processor; and
a memory having executable instructions stored thereon that when executed by the processor cause the processor to:
receive user information from a client device through a communication network;
transmit a signal to enable navigational tracking of the client device to record location data, the location data including an origination address and a destination address;
receive the location data from the client device through the communication network;
determine the user arrived at the destination address and distance traveled based on the location data from the client device;
populate a digital form with the location data, the distance traveled, and the user information; and
transmit the digital form to one or more receiving party devices.

13. The system of claim 12 wherein the location data includes a mode of transportation.

14. The system of claim 12 further comprising the processor determining a shortest route between the origination address and the destination address based on information received from a navigation server.

15. The system of claim 12 further comprising the processor transmitting the digital form via email, fax, or electronic file transmission over a network.

16. The system of claim 12 further comprising the processor receiving a scan or photograph of reimbursable items.

17. Non-transitory computer readable media comprising program code that when executed by a programmable processor causes execution of a method for creating an electronic record of traveled location and distance, the computer readable media comprising:
computer program code for receiving user information from a client device through a communication network;
computer program code for transmitting a signal to enable navigational tracking of the client device to record location, the location data including an origination address and a destination address;
computer program code for receiving the location data from the client device through the communication network;
computer program code for determining that the user arrived at the destination address and distance traveled based on the location data from the client device;
computer program code for populating a digital form with the location data, the distance traveled, and the user information; and
computer program code for transmitting the digital form to one or more receiving party devices.

18. The non-transitory computer readable media of claim 17 wherein the location data includes a mode of transportation.

19. The non-transitory computer readable media of claim 17 further comprising computer program code for determining a shortest route between the origination address and the destination address based on information received from a navigation server.

20. The non-transitory computer readable media of claim 17 further comprising computer program code for transmitting the digital form via email, fax, or electronic file transmission over a network.
